(19) United States
(12) Patent Application Publication
(10) Pub. No.: US 2022/0152686 A1
(43) Pub. Date: May 19, 2022

(54) Method of replacing bucket handles

(71) Applicant: Daniel L. Herrmann, Evansville, IN (US)

(72) Inventor: Daniel L. Herrmann, Evansville, IN (US)

(21) Appl. No.: 16/950,083

(22) Filed: Nov. 17, 2020

(51) Int. Cl. B21F 1/00; B65D 25/32

(52) U.S. Cl. CPC B21F 1/004; B65D 25/32

(57) ABSTRACT

The present invention is directed to a method and apparatus for replacing a bucket handle. The replacement handle is fashioned from a length of workable metal tubing. Holes are drilled where the original handle was attached, the holes slightly larger than the original mounting apertures. The tubing is bent into a desired shape and flattened at opposing ends. The drilled apertures are reinforced before fasteners are used to attach the flattened ends to the bucket.

### 1. FIELD OF THE INVENTION

The present invention generally relates to buckets. More specifically, the present invention relates to a method and apparatus for replacing a bucket handle.

### BACKGROUND OF THE INVENTION

The “standard” 5 gallon bucket is a fixture in most households. The vessels are used for various and sundry purposes and are generally functional for an acceptable period of use. However, a significant problem arises with these buckets over time. Due to the fact that the buckets are relatively large, they are frequently overloaded which can cause failure of the wire handle or bale. Once the handle is broken, the bucket is usually discarded due both to its low replacement cost and the fact that repairs often do not last.

Accordingly, there is a need for an inexpensive method and apparatus for replacing bucket handles, particularly 5 gallon bucket handles.

### SUMMARY OF THE INVENTION

The present invention is directed to a method and apparatus for replacing a bucket handle. The replacement handle is fashioned from a length of workable metal tubing. Holes are drilled where the original handle was attached, the holes slightly larger than the original mounting apertures. The tubing is bent into a desired shape and flattened at opposing ends. The drilled apertures are reinforced before fasteners are used to attach the flattened ends to the bucket.

It is a major object of the invention to provide an improved method and apparatus for replacing bucket handles.

It is another object of the invention to provide an improved method and apparatus for replacing bucket handles that is inexpensive.

It is another object of the invention to provide an improved method and apparatus for replacing bucket handles that can be fashioned from scrap parts.

It is another object of the invention to provide an improved method and apparatus for replacing bucket handles that reinforces the existing bucket at the attachment point.

### BRIEF DESCRIPTION OF THE DRAWINGS

FIG. 1 shows a side view of a bucket being modified in accordance with the method of the invention.

### DETAILED DESCRIPTION

The present invention provides an improved method for retrofitting a bucket. The bucket includes a cylindrically shaped container including an upper portion, and a wire member. The wire member includes first and second ends attached to the upper portion of the container; a central section intermediate the first and second ends; and, a gripping member mounted on the central section of the wire member. The improved method includes the steps of removing the wire member and gripping member and replacing with a one piece handle. The replacement handle includes a plurality of reinforcing components to improve the structural integrity of the bucket, especially around the original attachment point for the wire.

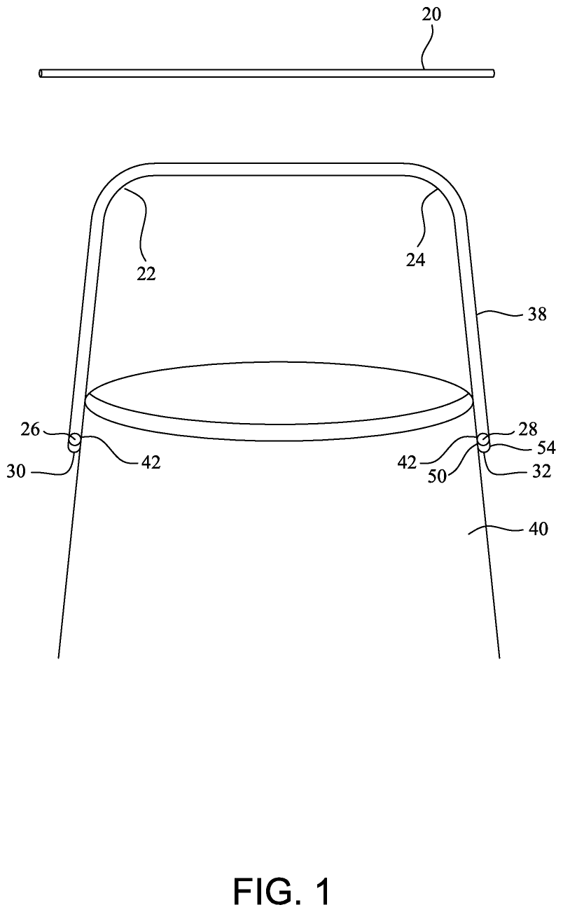

The method of the invention is practiced by starting with a length of metal tubing 20, as can be seen in FIG. 1. The tubing 20 is preferably EMT tubing such as that used to protect electrical cabling. Any tubing having a degree of pliability similar to EMT tubing may be used, but metal is the preferred material as it is durable and will not break down when exposed to sunlight. Also, as the tubing is round and has a larger diameter than a wire it will not dig into the user's hand and the need for a “grip” is obviated. For a 5 gallon bucket, the length of tubing should be about 32 inches but it can be appreciated that this length is selected in accordance with the size of the bucket or vessel being retrofitted.

The tubing 20 is then bent 90 degrees in 2 places using an appropriate tool such as an EMT bender. Both bends occur at about 11 inches from the ends of the tubing as shown by 22 and 24. A 1½ inch portion of the tubing is flattened at both ends to form opposing attachment points 26, 28. Apertures 30, 32 are formed as by drilling to provide a hole through which an attachment means, such as a bolt, may be threaded to allow for pivoting attachment of the replacement handle 38 to the bucket 40.

Opposing apertures 42 are then formed in the bucket 40, the apertures 42 positioned where the original apertures for the wire member were positioned. It can be appreciated that area around the original apertures can become damaged over time and thus may need reinforcement. Reinforcing is accomplished by providing at least two washers through which an elongated attachment member is threaded.

To install the replacement handle 38, apertures 30, 32 of the handle 38 are aligned with opposing apertures 42 formed in bucket 40. An elongated attachment member, such as a carriage bolt 44 is inserted through the aligned apertures 30, 32, 40. A nut 50 and a pair of washers 52, and 54 are used to secure the handle 38 in place. The washers 52 and 54 serve to reinforce the bucket 40 by reinforcing the area around the original aperture for the wire handle as this area can become damaged from the use of or removal of the wire handle.

In use, the user simply uses handle 38 to carry the bucket 40. The diameter of the tubing 20 used to form the handle 38 is such that a gripping member is not needed as the handle is sufficiently thick to avoid “digging” into the user's hand.

I claim:

1. A method of replacing a wire handle on a bucket comprising the steps of:
removing the wire handle;
forming a replacement handle by bending a length of tubing in two places to form a generally u-shaped replacement handle;
flattening said replacement handle at opposing ends, and forming apertures in said ends;
forming opposing apertures in an upper portion of said bucket;
aligning said apertures formed in the ends of the replacement handle with said bucket apertures;
inserting an attachment member through each of said aligned apertures and securing each of said attachment members within respective ones of said aligned apertures to attach said replacement handle to said bucket.

2. The method of claim 1 including the step of positioning a reinforcing member about each of said bucket apertures.

3. The method of claim 2 wherein said reinforcing member is a washer.

4. The method of claim 1 wherein said tubing is made of a pliable metallic material.

5. The method of claim 1 wherein said tubing is EMT tubing.

6. The method of claim 1 wherein said tubing is bent by an EMT bender.
